(19) United States
(12) Patent Application Publication
(10) Pub. No.: US 2020/0134579 A1
(43) Pub. Date: Apr. 30, 2020

(54) SYSTEMS AND METHODS FOR IDENTIFYING INDICATORS OF CRYPTOCURRENCY PRICE REVERSALS LEVERAGING DATA FROM THE DARK/DEEP WEB

(71) Applicant: Cyber Reconnaissance, Inc., Tempe, AZ (US)

(72) Inventors: Mohammed Almukaynizi, Tempe, AZ (US); Paulo Shakarian, Tempe, AZ (US); Malay Shah, Tempe, AZ (US)

(21) Appl. No.: 16/667,253

(22) Filed: Oct. 29, 2019

Related U.S. Application Data
(60) Provisional application No. 62/753,019, filed on Oct. 30, 2018.

(51) Int. Cl. G06Q 20/06; G06N 7/00; G06F 16/23; G06N 20/00; G06F 16/28; G06F 16/2458

(52) U.S. Cl. CPC G06Q 20/065; G06N 7/005; G06F 16/2474; G06N 20/00; G06F 16/285; G06F 16/2379

(57) ABSTRACT

Computer-implemented systems and methods are disclosed for learning correlations between D2web activity and historical cryptocurrency trend reversals. The learned correlations are leveraged to generate rules executable by a computing device. When satisfied, the rules are utilized to predict a cryptocurrency price reversal.

### CROSS REFERENCE TO RELATED APPLICATIONS

This is a non-provisional application that claims benefit to U.S. provisional patent application Ser. No. 62/753,019 filed on Oct. 30, 2018, which is herein incorporated by reference in its entirety.

### FIELD

The present disclosure generally relates to predictive cyber technologies; and in particular, to systems and methods for identifying indicators of future trend reversals of cryptocurrency using data gathered from the dark and deep web (D2web).

### BACKGROUND

The bitcoin system was developed to allow electronic cash (cryptocurrency) to be transferred directly from one party to another without going through a financial institution. A bitcoin (e.g., an electronic coin) is represented by a chain of transactions that transfers ownership from one party to another party. To transfer ownership of a bitcoin, a new transaction is generated and added to a stack of transactions in a block. The new transaction, which includes the public key of the new owner, is digitally signed by the owner with the owner's private key to transfer ownership to the new owner as represented by the new owner public key. Once the block is full, the block is “capped” with a block header that is a hash digest of all the transaction identifiers within the block. The block header is recorded as the first transaction in the next block in the chain, creating a mathematical hierarchy called a “blockchain.” To verify the current owner, the blockchain of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

To ensure that a previous owner of a bitcoin did not double-spend the bitcoin (i.e., transfer ownership of the same bitcoin to two parties), the bitcoin system maintains a distributed ledger of transactions. With the distributed ledger, a ledger of all the transactions for a bitcoin is stored redundantly at multiple nodes (i.e., computers) of a blockchain network. The ledger at each node is stored as a blockchain. In a blockchain, the transactions are stored in the order that the transactions are received by the nodes. Each node in the blockchain network may have a complete replica of the entire blockchain. The bitcoin system also implements techniques to ensure that each node will store the identical blockchain even though nodes may receive transactions in different orderings. To verify that the transactions in a ledger stored at a node are correct, the blocks in the blockchain can be accessed from oldest to newest, generating a new hash of the block and comparing the new hash to the hash generated when the block was created. If the hashes are the same, then the transactions in the block are verified. The bitcoin system also implements techniques to ensure that it would be infeasible to change a transaction and regenerate the blockchain by employing a computationally expensive technique to generate a nonce that is added to the block when it is created.

Because most commerce is conducted using fiat currency rather than cryptocurrency, exchange organizations have been established to exchange cryptocurrency to fiat currency, and vice versa. For example, to exchange bitcoin for fiat currency, the owner of the bitcoin would transfer an amount of bitcoin to the exchange organization. The exchange organization would then determine the current exchange rate and credit a bank account (or other account) of the user with an amount of fiat currency corresponding to the amount of bitcoin, less a service fee. The user can then spend the fiat currency in their bank account. Various blockchain-based systems have been developed to provide other types of cryptocurrencies. For example, Ethereum provides ether and Litecoin provides litecoin.

Any number of bitcoin trade transactions may take place during a given day in the cryptocurrency marketplace. To support bitcoin trade decisions, it is very important for cryptocurrency traders to observe a price trend and identify whether a reversal is imminent. Yet, this is notoriously a difficult task due to the high number of variables influencing the trend. It is with these observations in mind, among others, that various aspects of the present disclosure were conceived and developed.

### BRIEF DESCRIPTION OF THE DRAWINGS

FIG. 1 is a simplified block diagram showing a computer-implemented system for identifying indicators of cryptocurrency price reversals by leveraging data from the dark and deep web.

FIG. 2 is a simplified block diagram of a possible computer-implemented method of applying aspects of the system of FIG. 1 for identifying indicators of cryptocurrency price reversals by leveraging data from the dark and deep web.

FIG. 3 is a simplified block diagram showing another embodiment of a computer-implemented system for identifying indicators of cryptocurrency price reversals by leveraging data from the dark and deep web.

FIG. 4 is a simplified block diagram of a possible computer-implemented method of applying aspects of the system of FIG. 3 for identifying indicators of cryptocurrency price reversals by leveraging data from the dark and deep web.

FIG. 5 is a graph illustrating examples of cryptocurrency trend reversals.

FIG. 6 is an example simplified schematic diagram of a computing device that may implement various methodologies described herein.

Corresponding reference characters indicate corresponding elements among the view of the drawings. The headings used in the figures do not limit the scope of the claims.

### DETAILED DESCRIPTION

Aspects of the present disclosure relate to a computer-implemented system and associated methods for identifying indicators of future trend reversals of cryptocurrency using data gathered from the dark and deep web (D2web) and building rules (.e.g., logic-based) executable by a processor in view of new cryptocurrency data for predicting cryptocurrency price reversals based on preconditions corresponding to the indicators of the rules. In some embodiments, the system leverages concepts from probability theory, statistical learning, and causality reasoning to learn correlations between D2web activity and trend reversals from historical cryptocurrency price movement data to generate the rules. Once indicators are identified and rules are generated, monitoring the D2web for occurrences of the indicators may directly support trade decisions.

In some embodiments, the indicators are based on mentions of entities extracted from deep/dark web data. In these embodiments, the entity mentions may be mapped to time points and compared with historical cryptocurrency price reversals to derive a set of logic-based rules using Annotated Probabilistic Temporal (APT) logic, or otherwise. The rules may subsequently be refined or adjusted to maximize utility as further described herein.

### Introduction and Technical Challenges of Identifying Cryptocurrency Price Reversals

As described herein, cryptocurrency traders often need to observe a bitcoin price trend and identify whether a reversal is imminent. A cryptocurrency reversal is generally defined as a recognizable change in the price trend, positive (i.e., raising) or negative (i.e., falling). The identification of a reversal depends on how it is defined, and this varies from market to another and from analyst to another.

Some of the current commonly used automated approaches that forecast cryptocurrency price movement are totally based on the price change in the recent past; while other approaches leverage techniques such as machine learning to take into consideration feeds from the news outlets or changes in trade volume from crypto exchanges. Although proven to yield improved forecasting, such approaches ignore information from the underground side of the internet such as the dark web and deep web, platforms that have been famous of being among the favorite platforms for actors with malicious intent. The dark web and deep web (collectively, “D2web”) is a part of the internet that is not indexed by regular search engines or public DNS providers. Dark web sites are only accessible though clients that use hidden service protocols like Tor. These protocols are designed to preserve the anonymity and location of clients and servers. The deep web is a collection of sites that are not indexed nor publically accessible. Unlike the dark web, only authorized users can access deep web sites via regular Web browsers.

Platforms associated with the D2web enable their users to preserve anonymity while contributing or browsing content that can directly disturb the cryptocurrency markets, such as organizing collective trades, publishing data about breached wallets, or purchasing computer exploit scripts that can subsequently be used in ransomware cyberattack with ransom payable in cryptocurrency.

### Proposed Technical Improvement to Identifying Indicators of Cryptocurrency Price Reversals

In response to the technical challenges above, the present inventive system improves upon prior methods for predicting cryptocurrency price reversals by applying concepts from probability theory, statistical learning, and causality reasoning to learn temporal correlations between D2web activity and trend reversals from historical cryptocurrency price movement data in order to identify possible indicators of a cryptocurrency price reversal. As such, the present system is a technical improvement over previous methods as it does not merely rely upon historical price changes or general machine learning; but rather, e.g., learns temporal correlations between predetermined indicators derived from the deep or dark web, and historical cryptocurrency price movement data, as described herein.

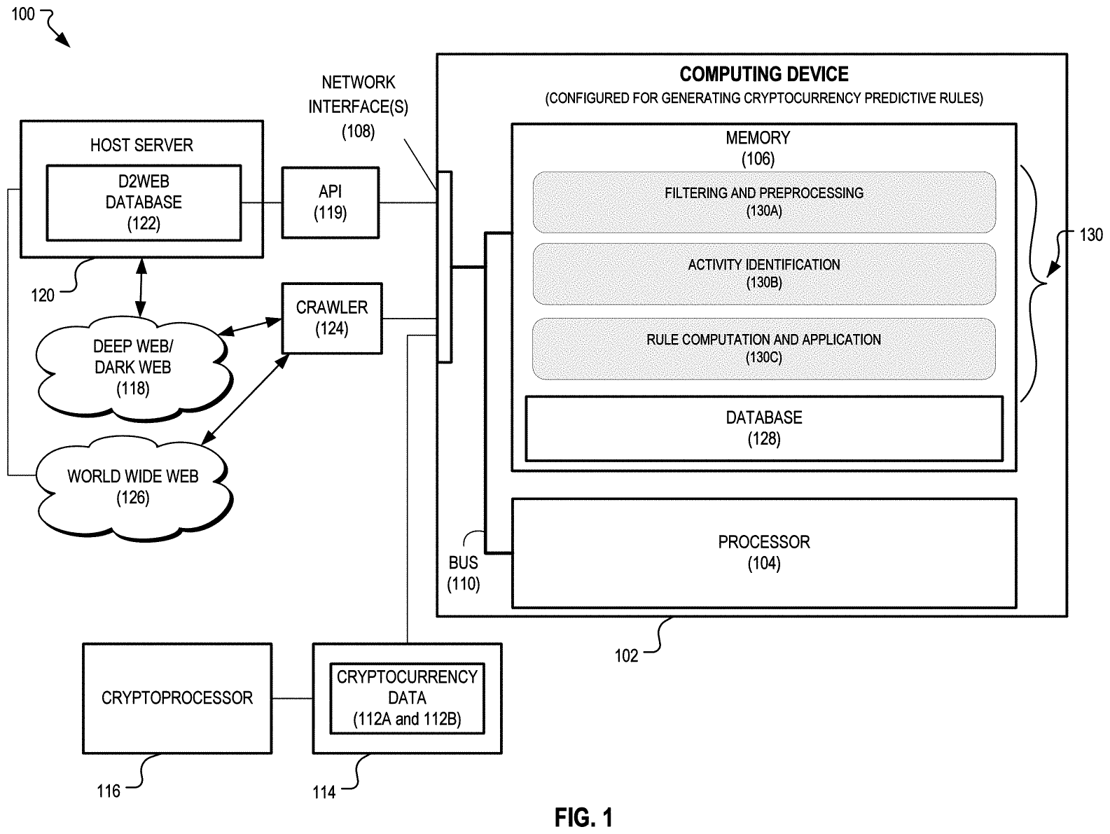

Referring to FIG. 1, one embodiment of a computer-implemented system is shown, designated system 100, which may be utilized for implementing functionality associated with computer-implemented cryptocurrency predictive methods, as described herein. In general, the system 100 comprises a computing device 102 including a processor 104, a memory 106 of the computing device 102 (or separately implemented), a network interface (or multiple network interfaces) 108, and a bus 110 (or wireless medium) for interconnecting the aforementioned components. The network interface 108 includes the mechanical, electrical, and signaling circuitry for communicating data over links (e.g., wires or wireless links) within a network (e.g., the Internet). The network interface 108 may be configured to transmit and/or receive data using a variety of different communication protocols, as will be understood by those skilled in the art.

As indicated, via the network interface 108 or otherwise, the computing device 102 is adapted to access cryptocurrency data 112 which may be stored/aggregated within a memory 114 (or locally stored within the memory 106). The cryptocurrency data 112 includes historical cryptocurrency data 112A and/or current/new cryptocurrency data 112B which is leveraged by the computing device 102 to derive functions or rules suitable for identifying fluctuations in the cryptocurrency markets, as further described herein. In addition, the system 100 includes a cryptoprocessor 116 for generating aspects of the historical cryptocurrency data 112A and/or the current/new cryptocurrency data 112B which may be in operable communication with the computing device 102 to provide real-time information about changes in cryptocurrency markets and trends.

In addition, the computing device 102 is further adapted, via the network interface 108 or otherwise, to access data from the deep or dark web (D2web) 118. In some embodiments, the computing device 102 accesses such D2Web data by engaging an application programming interface 119 to establish a temporary communication link with a host server 120 storing a database 122 of data D2web data. Alternatively, or in combination, the computing device 102 may be configured to implement a crawler 124 (or spider or the like) to extract data from the deep/dark web 118 without aid of a separate device (e.g., host server 120). Further, the computing device 102 may access data from the general Internet or World Wide Web 126 as needed, with or without aid from the host server 120.

The data from the deep/dark web 118 and the cryptocurrency data 112 aggregated or accessed by the computing device 102 may be stored within a database 128. Once this data is accessed and/or stored in the database 128, the processor 104 is operable to execute a plurality of services 130 to process the data so as to determine temporal correlations and generate rules or functions predictive of a cryptocurrency trend or reversal, as further described herein. The services 130 of the system 100 may include, without limitation, a filtering and preprocessing service 130A, an activity identification service 130B, and a rule computation and application service 130C, further described herein. The plurality of services 130 may include any number of components or modules executed by the processor 104 or otherwise implemented. Accordingly, in some embodiments, one or more of the plurality of services 130 may be implemented as code and/or machine-executable instructions executable by the processor 104 that may represent one or more of a procedure, a function, a subprogram, a program, a routine, a subroutine, a module, an object, a software package, a class, or any combination of instructions, data structures, or program statements, and the like. In other words, one or more of the plurality of services 130 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 106), and the processor 104 performs the tasks defined by the code.

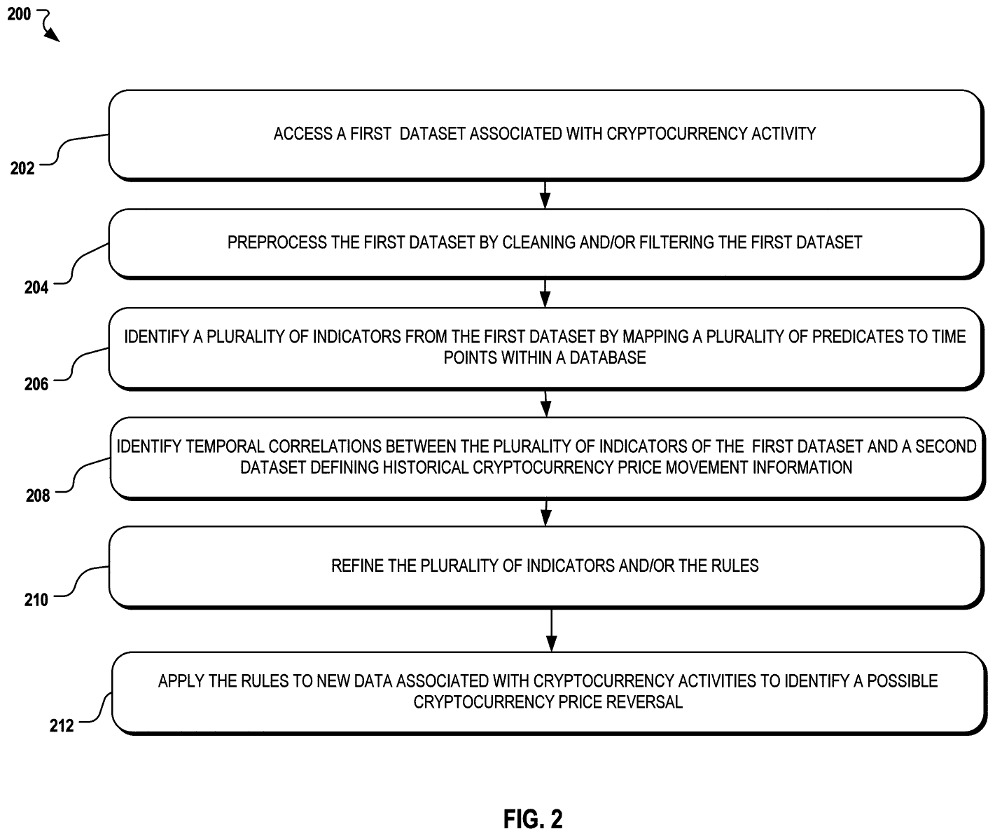

Referring now to a process flow diagram 200 of FIG. 2, aspects of the plurality of services 130 and implementation of the system 100 shall now be described. Referring to block 202, a first dataset, or any number datasets associated with cryptocurrency and originating from the deep or dark web 118 (D2web data) may be accessed, collected, or acquired as illustrated in FIG. 1. The first dataset may include information from, by non-limiting examples, dark web forums, blogs, marketplaces, intelligence threat APIs, data leaks, data dumps, and the like, and may be acquired using web crawling, RESTful HTTP requests, HTML parsing, or any number or combination of such methods.

In one specific embodiment, using the API 119, the first dataset may be acquired from a remote database, such as database 122 hosted by, e.g., host server 120. In this embodiment, the host server 120 gathers D2web data from any number of D2web sites or platforms and makes the data accessible to other devices. More particularly, the computing device 102 issues an API call to the host server 120 using the API 119 to establish a RESTful Hypertext Transfer Protocol Secure (HTTPS) connection. D2web data from the D2web database 122 may then be transmitted to the computing device 102 in an HTTP response with content provided in key-value pairs (e.g., JSON).

Referring to block 204 and the filtering and preprocessing service 130A executable by the computing device 102, the first dataset may be preprocessed by, e.g., cleaning the first dataset in some form, filtering the first dataset, changing the format of the first dataset, or modeling the first dataset in some predetermined fashion. Such preprocessing may be applied to aid with identification of indicators of activity associated with a possible cryptocurrency reversal. For example, in some embodiments, the first dataset may be processed by applying text translation, topic modeling, content tagging, social network analysis, or any number or combination of artificial intelligence methods such as machine learning applications. Any of the data cleaning techniques can be used to filter the cryptocurrency-related content of the first dataset from other content commonly discussed in the D2web such as drug-related discussions or pornography.

Referring to block 206 and the activity identification service 130B executable by the computing device 102, a plurality of indicators of possible activity associated with a possible cryptocurrency price reversal may be identified by mapping a plurality of predicates or atoms from the first dataset to a series of predefined time points (e.g., x number of days). Predicates of possible cryptocurrency price reversals may be in the form of keywords, characters, numerical values, or other forms of text, strings, or any other data structures and may relate to any abnormalities or abnormal activities, predetermined, or learned, that are potentially indicative of a cryptocurrency price reversal. Any number of techniques may be implemented to identify such predicates, such as text feature extractors (e.g., keyword match checkers, regular expression extractors, and natural language processing techniques), user-based feature extractors (e.g., predicates may include a number of users contributing to a forum thread and features from the social network of the authors of posts), and site-based feature extractors (e.g., predicates may include an age of a site, a number of topics, a number of active users, and languages used).

In some embodiments, the computing device 102 maps the predicates to a series of time points and stores each mapped predicate within the database 128 such that each row in the database 128 corresponds to a row; i.e., each row of the database 128 defines a 2-tuple with a predicate mapped to a time period, such as a specific date and/or time. In these embodiments, the database 128 may define a time series database optimized for time-stamped data or time series data. The database 128 may further be adapted for computation by the processor 104 of a percentile increase in references to particular predicates/keywords from the first dataset over a predetermined period of time.

Referring to block 208 and the rule computation and application service 130C executable by the computing device 102, the computing device 102 may leverage the first dataset along with a second dataset comprising historical cryptocurrency price reversal information (accessed from the memory 114 or otherwise), identify temporal correlations between the first dataset and the second dataset, and generate a plurality of rules for predicting future possible cryptocurrency price reversals. In some embodiments, the computing device 102 executes the rule computation and application service 130C to select a subset or certain ones of the plurality of indicators by learning temporal correlations between these indicators and the historical cryptocurrency price reversal information of the second dataset. Any number of different techniques or combinations thereof may be employed. For example, the computing device 102 may derive selected indicators from the first dataset and the second dataset using statistical approaches such as decisions trees, logistic regression, or may employ knowledge representation and reasoning (KRR) approaches such as inductive reasoning, or logic programming.

In some embodiments, the rules ultimately generated by the computing device 102 may generally comprise logic or functions that evaluate to true or false, when an indicator of some activity “spikes”; i.e., the indictor is referenced or appears over time in an amount or frequency that meets or exceeds a predefined threshold. To illustrate, one non-limiting example of an indicator may include a predicate in the form of a keyword, “SELL,” mapped to a time point. In this example, the indicator is generally defined as identification of the predicate, SELL, within the first dataset over time. Leveraging or referencing historical cryptocurrency data 112A, the computing device 102 may extrapolate temporal correlations between references to the term SELL over time and learn how increases in references (to a computed magnitude) to the term SELL have historically shown to be indicative of a cryptocurrency reversal for some cryptocurrency, “CRYPTOCURRENCY.” Learned temporal correlations may then be modeled or transformed to probabilistic rules executable by the computing device 102 when presented with new cryptocurrency data, e.g., D2web data or data associated with the deep or dark web, or any data containing aspects of the learned rules/correlations. The probability of rules models the chance that a cryptocurrency price reversal is observed in the historical data following occurrences of observing the identified indicator within some time window, Δt.

In some embodiments, a rule in the aforementioned example, may be defined as an expression, executable by the computing device 102, that predicts a cryptocurrency price reversal following a spiking indicator:

IF spiking(SELL)=True, THEN reversal(CRYPTOCURRENCY)=True, WITHIN Δt time-points, WITH PROBABILITY p

where the predicate spiking(SELL) evaluates to “True” if the number of references, instances, or mentions of the term, SELL, over a predetermined time period, t, exceeds a predetermined threshold. Accordingly in these embodiments, rules are learned based on predicates that evaluate to true. It should be understood that the above function is merely exemplary, and any number of like functions or expressions may embody the rules described herein, such as conditional statements, Boolean expressions, predication, and the like.

Referring to block 210, any of the plurality of rules may be refined, adjusted, or modified as desired. In some embodiments, refinement of the rules may include application by the computing device 102 of any number of techniques, such filtering/adjusting the rules or the indicators integrated within the rules based on experiences or data provided by analysists or any other external resources, generalizing indicators of reversals for different cryptocurrencies, adjusting parameters of the rules, or applying weights to the rules, and the like.

Referring to block 212, the rules may be applied to new cryptocurrency data 112B to identify a possible imminent cryptocurrency price reversal. More specifically, the computing device 102 may access, in real-time or otherwise, new cryptocurrency data 112B generated by the cryptoprocessor 116 so that the computing device 102 can determine whether a possible cryptocurrency price reversal is pending. Similar to the first dataset, this data may include textual information, or any information potentially including one or more of the indicators and/or possibly satisfying one of the rules generated in block 210. Using the methods defined in block 204 and defined by the filtering and preprocessing service 130A, the computing device 102 may pre-process the new cryptocurrency data 112B in order to model the data or format the data in some form such that the computing device 102 can identify the indicators (e.g., identify instances of the keyword, SELL) within the new cryptocurrency data 112B. Upon preprocessing the new cryptocurrency data 112B, the rule computation and application service 130C may be executed by the computing device such that the computing device 102 may filter through the new cryptocurrency data 112B as preprocessed, and indicate whether any of the rules generated in block 208 are met or satisfied by the new cryptocurrency data 112B (e.g., instances of the keyword SELL over a given time period exceed a predefined threshold). As described herein, satisfaction of a rule may predict a possible cryptocurrency price reversal.

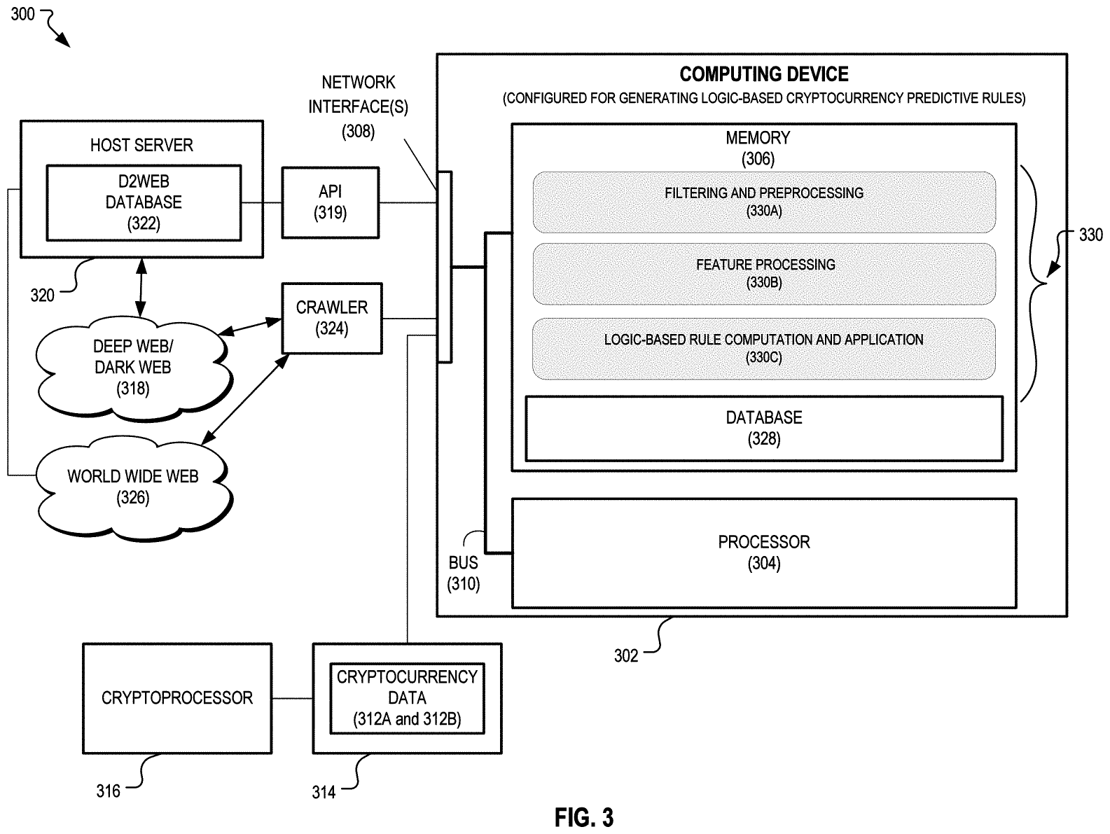

Referring to FIG. 3, another embodiment of a computer-implemented system is shown, designated system 300, which may also be utilized for implementing functionality associated with computer-implemented cryptocurrency predictive methods, as described herein. In general, the system 300 comprises a computing device 302 including a processor 304, a memory 306 of the computing device 302 (or separately implemented), a network interface (or multiple network interfaces) 308, and a bus 310 (or wireless medium) for interconnecting the aforementioned components. The network interface 308 includes the mechanical, electrical, and signaling circuitry for communicating data over links (e.g., wires or wireless links) within a network (e.g., the Internet). The network interface 308 may be configured to transmit and/or receive data using a variety of different communication protocols, as will be understood by those skilled in the art.

As indicated, via the network interface 308 or otherwise, the computing device 302 is adapted to access cryptocurrency data 312 which may be stored/aggregated within a memory 314 (or locally stored within the memory 306). The cryptocurrency data 312 includes historical cryptocurrency data 312A and/or current/new cryptocurrency data 312B which is leveraged by the computing device 302 to derive functions or rules suitable for identifying fluctuations in the cryptocurrency markets, as further described herein. In addition, the system 300 includes a cryptoprocessor 316 for generating aspects of the historical cryptocurrency data 312A and/or the current/new cryptocurrency data 312B which may be in operable communication with the computing device 302 to provide real-time information about changes in cryptocurrency markets and trends.

In addition, the computing device 302 is further adapted, via the network interface 308 or otherwise, to access data from the deep or dark web (D2web) 318. In some embodiments, the computing device 302 accesses such D2web data by engaging an application programming interface 319 to establish a temporary communication link with a host server 320 storing a database 322 of data D2web data. Alternatively, or in combination, the computing device 302 may be configured to implement a crawler 324 (or spider or the like) to extract data from the deep/dark web 318 without aid of a separate device (e.g., host server 320). Further, the computing device 302 may access data from the general Internet or World Wide Web 326 as needed, with or without aid from the host server 320.

The data from the deep/dark web 318 and the cryptocurrency data 312 aggregated or accessed by the computing device 302 may be stored within a database 328. Once this data is accessed and/or stored in the database 328, the processor 304 is operable to execute a plurality of services 330 to process the data so as to determine temporal correlations and generate rules or functions predictive of a cryptocurrency trend or reversal. The services 330 of the system 300 may include, without limitation, a filtering and preprocessing service 330A, a feature processing service 330B, and a logic-based rule computation and application service 330C, further described herein. The plurality of services 330 may include any number of components or modules executed by the processor 304 or otherwise implemented. Accordingly, in some embodiments, one or more of the plurality of services 330 may be implemented as code and/or machine-executable instructions executable by the processor 304 that may represent one or more of a procedure, a function, a subprogram, a program, a routine, a subroutine, a module, an object, a software package, a class, or any combination of instructions, data structures, or program statements, and the like. In other words, one or more of the plurality of services 330 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 306), and the processor 304 performs the tasks defined by the code.

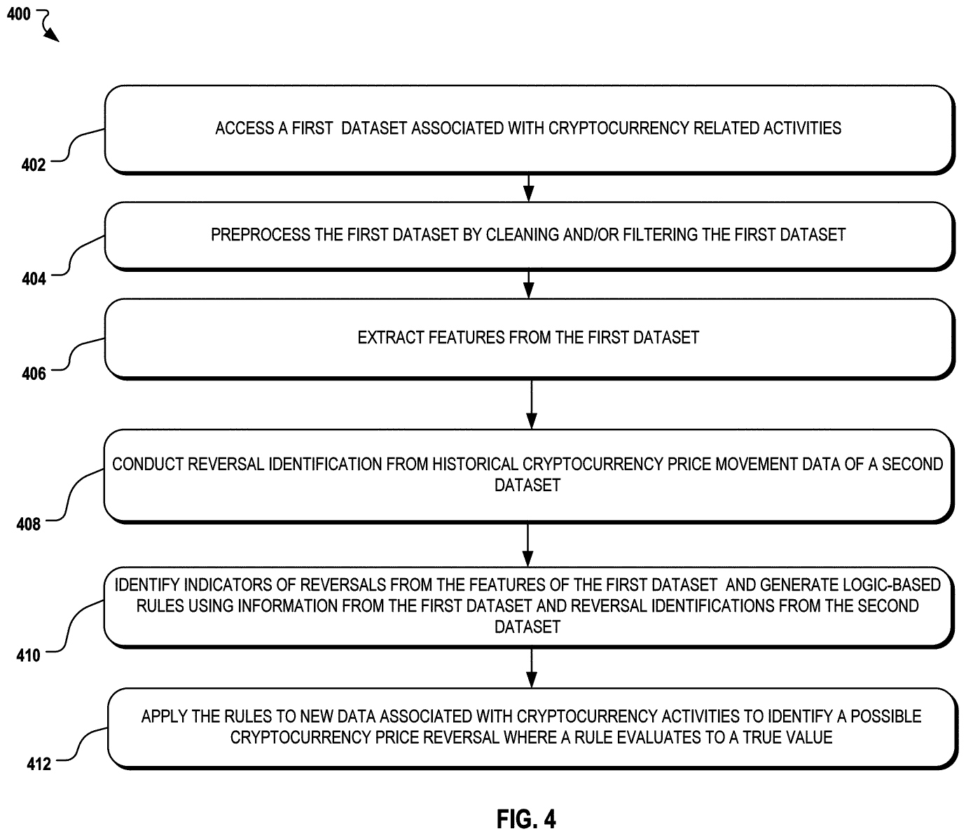

Referring now to a process flow diagram 400 of FIG. 4, aspects of the plurality of services 330 and implementation of the system 300 shall now be described. Referring to block 402, a first dataset, or any number datasets associated with cryptocurrency and originating from the deep or dark web 318 (D2web data) may be accessed, collected, or acquired as illustrated in FIG. 3. The first dataset may include information from, by non-limiting examples, dark web forums, blogs, marketplaces, intelligence threat APIs, data leaks, data dumps, and the like, and may be acquired using web crawling, RESTful HTTP requests, HTML parsing, or any number or combination of such methods.

In one specific embodiment, using the API 319, the first dataset may be acquired from a remote database, such as database 322 hosted by, e.g., host server 320. In this embodiment, the host server 320 gathers D2web data from any number of D2web sites or platforms and makes the data accessible to other devices. More particularly, the computing device 302 issues an API call to the host server 320 using the API 319 to establish a RESTful Hypertext Transfer Protocol Secure (HTTPS) connection. D2web data from the D2web database 322 may then be transmitted to the computing device 302 in an HTTP response with content provided in key-value pairs (e.g., JSON).

Referring to block 404 and the filtering and preprocessing service 330A executable by the computing device 302, the first dataset may be preprocessed by, e.g., cleaning the first dataset in some form, filtering the first dataset, changing the format of the first dataset, or modeling the first dataset in some predetermined fashion. Such preprocessing may be applied to aid with identification of indicators of activity associated with a possible cryptocurrency reversal. For example, in some embodiments, the first dataset may be processed by applying text translation, topic modeling, content tagging, social network analysis, or any number or combination of artificial intelligence methods such as machine learning applications. Further, any of the data cleaning techniques can be used to filter the cryptocurrency-related content of the first dataset from other content commonly discussed in the D2web such as drug-related discussions or pornography. In some embodiments, the subject step of block 404 filters the first dataset to purely textual information, such that certain text/character features may be identified from the first dataset.

Referring to block 406 and the feature processing service 330B executable by the computing device 302, features may be extracted from the first dataset. In some embodiments, using a natural language processing (NLP) technique, named-entity recognition, one or more neural network models trained to identify entities from text, or otherwise, the computing device 302 is adapted to generate a set of entities from the first dataset. With named-entity recognition, for example, the computing device 302 executes the feature processing service 330B to locate and classify entity mentions within the first dataset (structured or unstructured). The computing device 302 may classify named entities that are present in textual information of the first dataset into pre-defined categories such as PLACES, USERS, CRYPTOCURRENCY, CRYPTOCURRENCY PRICE, and the like. So for example, if the first dataset comprises two blog posts extracted from the deep/dark web 318, the computing device 302 executes the feature processing service 330B, classifies the aforementioned exemplary entities, and outputs/generates a set of tagged entities, or tags, with values assigned to entities mentioned within each of the two digital documents. An example output may be represented as follows (and be displayed by a display 560):
First blog post
Type: CRYPTOCURRENCY, Value: Bitcoin
Type: USER, Value: John Doe
Type: CRYPTOCURRENCY, Value: Bitcoin
Second blog post
Type: CRYPTOCURRENCY, Value: Litecoin
Type: USER, Value: John Doe
Type: CRYPTOCURRENCY, Value: Bitcoin

In addition, each of the above entity mentions may relate to a particular time point or be assigned a time stamp. For example, the first entity mention of “Bitcoin” from the first blog post corresponding to a mentioned cryptocurrency entity/classification may occur at 12:00 pm on November 1; whereas the entity mention of “Litecoin” from the second blog post may occur at 2:00 pm on November 1. In addition, as illustrated, named entities may be mentioned multiple times. Note in the example above that the entity of “Bitcoin” is mentioned multiple times (within both blog posts), and is mentioned twice within the first blog post.

In some embodiments, entity mentions/tags may be tracked according to the day when the entity is mentioned. In this manner, for each day and entity, the computing device 302 is adapted to determine whether there is a “spike” in the number of mentions for that entity. Spikes may be determined by the number of mentions of an entity on a given day compared to the number of mentions of the same entities in n (e.g., 20) preceding days. Two statistical measures may be used to determine spiking tags: median of the number of mentions in the 20 preceding days and standard deviation of this quantity over the same period. The spikes may be determined based on a formula of these two measures, which may take the following non-limiting form:

Number of mentions on day d>(n*standard deviation of preceding days)+median of preceding days

For example, if the median of the number of mentions for a tag x is 10 for the 20 days preceding the examined day, standard deviation is 3, variable n is 2, and x was mentioned 17 times, then x is spiking; because:

17>(2*3)+10 [symbol] 17>16

In one exemplary use case, setting n to 2, the aforementioned process was tested and executed by a computing device on all the days for a period of 8 months, starting from October 1^{st}, to May 31^{st}, of a particular year, and was able to identify over 160,000 spiking tags from around 1.7 million D2web posts from the deep/dark web 318.

Referring to block 408, the computing device 302 is further adapted to identify reversals or conduct reversal identification from a second dataset, e.g., historical cryptocurrency data 312A. For each time-point (in this case day), it is determined whether that day precedes a future reversal—reversal to happen within the next 5 days. To do so, reversals are identified for each day d using three quantities: (1) the difference (diff_{d}) between the maximum and minimum closing price of the next 7 days; and (2) the standard deviation (std_div_diff_{d}), and (3) the average (avg_diff_{d}) of quantity (1) for the 20 days preceding d. With those quantities, d is labeled as preceding a reversal if:

diff_{d}≥1.5*std_div_diff_{d}+avg_diff_{d}

This condition is checked for all days in the historical data of this experiment to identify cryptocurrency price reversals.

Referring to block 410, the computing device 302 may identify indicators of reversals, and generate logic-based rules for predicting a cryptocurrency reversal by identifying temporal correlations between the features of the first dataset and the reversal identifications of the second dataset. In some embodiments, the extracted features (spiking tags) are stored in the database 328, where each row of the database 328 is a 2-tuple, i.e., (tag, date). In the same database 328, a list of identified dates on which Bitcoin price experienced reversals is also stored. The goal is to identify from the large number of the tags the ones that, when mentioned very frequently, relate to a likelihood of experiencing a price reversal within the next 7 days increasing significantly as compared to the probability of a reversal happening in any sequence of 7 days.

In some embodiments, a temporal logic programming approach, known as Annotated Probabilistic Temporal (APT) Logic Rule Learning, is used. This approach outputs a set rules (called logic program), each is of the form “a trend reversal will occur within t days following a spike in the mention of tag f with probability p,” and may be depicted in the form:

f→ₚ^{t}g

Where f is known as the pre-condition, g is the consequence, and t is the number of days within which a reversal is predicted. For this very embodiment, g is always “Cryptocurrency trend reversal”, and t is 7. The probability p is computed as follows:

$$\frac{the number of times f occured followed by g within t days}{the number of times f occurs}$$

The denominator of the above formula is often referred to as a “support count”. In many ways, the computation of this probability is similar to a precision measure. However, the precise computation of this value must also consider edge-cases in the time horizon. When the pre-condition is a simple atomic statement, like in the subject developed embodiment, learning of such rules is efficiently computed by the computing device 302, reducing computation load affecting other methods.

In addition, in some embodiments, the significance of a rule is determined based on the percentage increase of its probability over the probability if a null rule with the same consequence. A null rule is of the form:

True→ₚ^{t}g

In words, the null rule probability is the most likely probability value that a trend reversal will occur within t days following any random day. With those concepts explained intuitively, the subject embodiment may employ a computing algorithm called APT-EXTRACT, which utilizes APT logic rule learning to compute a logic program executable by the computing device 302 for identifying possible reversals of cryptocurrency prices in view of new cryptocurrency data 312B.

Example of the Identified Indicators

The described systems produced over 3,400 rules with improved probabilities; and a fraction of this number is the rules that have relatively high support counts. Table 1 below shows examples of the learned rules.

TABLE 1
Example indicators of Bitcoin trend reversals

| Indicator | Probability | Null rule probability |
|---|---|---|
| Bitcoin and Website | 0.5 | 0.429378531 |
| Data and Google | 0.666667 | 0.429378531 |
| IOS jailbreaking and | 0.666667 | 0.429378531 |
| Security hacker | | |
| Money and Telephone | 0.95 | 0.429378531 |
| Android (operating | 0.7 | 0.429378531 |
| system) | | |
| IOS | 0.625 | 0.429378531 |

### Case Studies

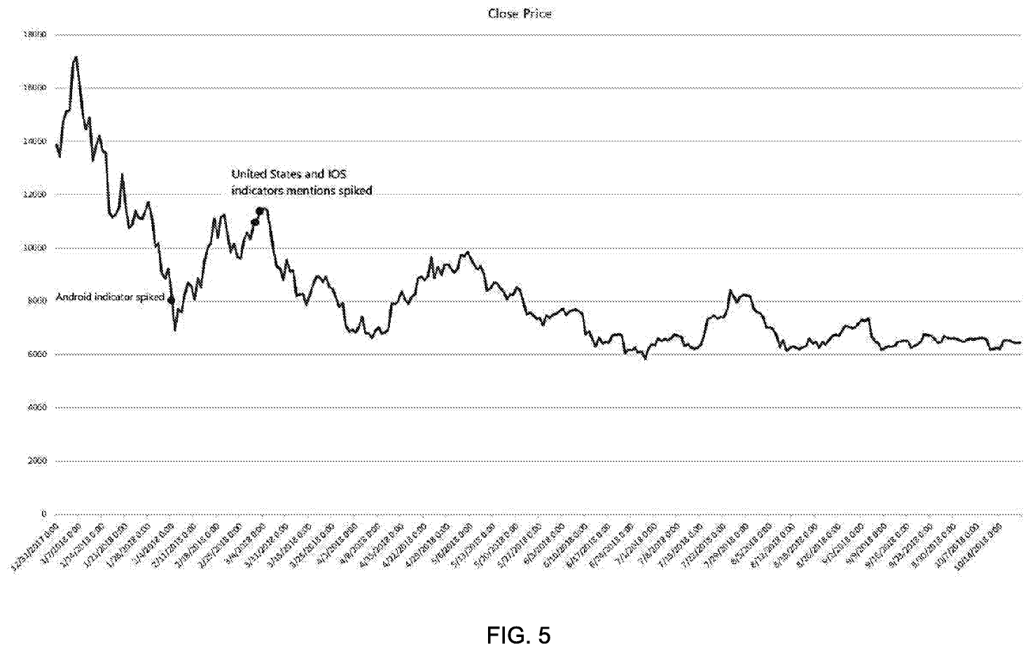

Referring to FIG. 5, a graph shows the closing price of Bitcoin from Jan. 1, 2018-Oct. 15, 2018. The points in the graph show three examples of when some of the identified indicators spiked. Those spikes were shortly followed by recognizable trend reversals.

Case 1:

Android (Operating System): In the table of rules above, probability of a reversal occurring after tag Android (operating system) spikes is 0.7. In the graph shown in FIG. 5, the same tag is mentioned on February 3; and on February 5, a reversal was observed.

Case 2:

IOS (Operating System): The probability of a reversal happening after a spiking volume of IOS mentions is 0.625. The indicator of IOS is mentioned on March 3, and a notable reversal was observed on March 7.

### Exemplary Computing Device

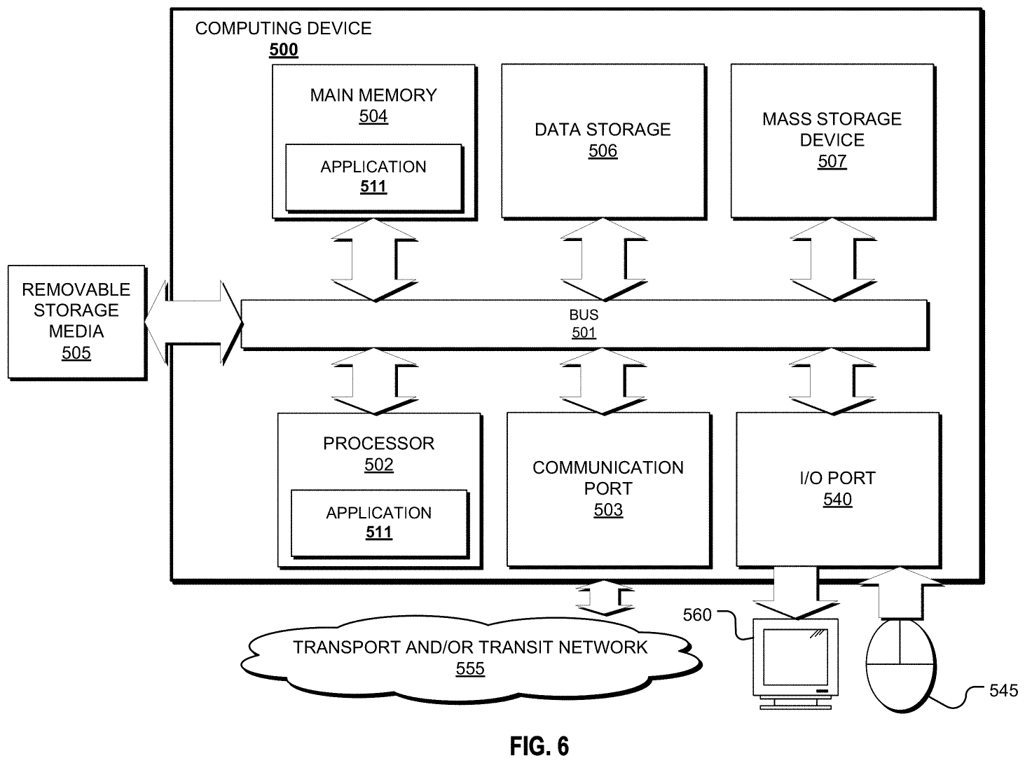

Referring to FIG. 6, a computing device 500 is illustrated which may take the place of either of the computing device 102 or the computing device 302 and be configured, via an application 511, to execute functionality associated with any of the cryptocurrency predictive functionality or methods as described herein. More particularly, in some embodiments, aspects of the cryptocurrency predictive methods may be translated to software or machine-level code, which may be installed to and/or executed by the computing device 500 such that the computing device 500 is configured to generate rules executable for predicting a cryptocurrency price reversal as described herein. It is contemplated that the computing device 500 may include any number of devices, such as personal computers, server computers, hand-held or laptop devices, tablet devices, multiprocessor systems, microprocessor-based systems, set top boxes, programmable consumer electronic devices, network PCs, minicomputers, mainframe computers, digital signal processors, state machines, logic circuitries, distributed computing environments, and the like.

The computing device 500 may include various hardware components, such as a processor 502, a main memory 504 (e.g., a system memory), and a system bus 501 that couples various components of the computing device 500 to the processor 502. The system bus 501 may be any of several types of bus structures including a memory bus or memory controller, a peripheral bus, and a local bus using any of a variety of bus architectures. For example, such architectures may include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computing device 500 may further include a variety of memory devices and computer-readable media 507 that includes removable/non-removable media and volatile/nonvolatile media and/or tangible media, but excludes transitory propagated signals. Computer-readable media 507 may also include computer storage media and communication media. Computer storage media includes removable/non-removable media and volatile/nonvolatile media implemented in any method or technology for storage of information, such as computer-readable instructions, data structures, program modules or other data, such as RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information/data and which may be accessed by the computing device 500. Communication media includes computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. For example, communication media may include wired media such as a wired network or direct-wired connection and wireless media such as acoustic, RF, infrared, and/or other wireless media, or some combination thereof. Computer-readable media may be embodied as a computer program product, such as software stored on computer storage media.

The main memory 504 includes computer storage media in the form of volatile/nonvolatile memory such as read only memory (ROM) and random access memory (RAM). A basic input/output system (BIOS), containing the basic routines that help to transfer information between elements within the computing device 500 (e.g., during start-up) is typically stored in ROM. RAM typically contains data and/or program modules that are immediately accessible to and/or presently being operated on by processor 502. Further, data storage 506 in the form of Read-Only Memory (ROM) or otherwise may store an operating system, application programs, and other program modules and program data.

The data storage 506 may also include other removable/non-removable, volatile/nonvolatile computer storage media. For example, the data storage 506 may be: a hard disk drive that reads from or writes to non-removable, nonvolatile magnetic media; a magnetic disk drive that reads from or writes to a removable, nonvolatile magnetic disk; a solid state drive; and/or an optical disk drive that reads from or writes to a removable, nonvolatile optical disk such as a CD-ROM or other optical media. Other removable/non-removable, volatile/nonvolatile computer storage media may include magnetic tape cassettes, flash memory cards, digital versatile disks, digital video tape, solid state RAM, solid state ROM, and the like. The drives and their associated computer storage media provide storage of computer-readable instructions, data structures, program modules, and other data for the computing device 500.

A user may enter commands and information through a user interface 540 (displayed via a monitor 560) by engaging input devices 545 such as a tablet, electronic digitizer, a microphone, keyboard, and/or pointing device, commonly referred to as mouse, trackball or touch pad. Other input devices 545 may include a joystick, game pad, satellite dish, scanner, or the like. Additionally, voice inputs, gesture inputs (e.g., via hands or fingers), or other natural user input methods may also be used with the appropriate input devices, such as a microphone, camera, tablet, touch pad, glove, or other sensor. These and other input devices 545 are in operative connection to the processor 502 and may be coupled to the system bus 501, but may be connected by other interface and bus structures, such as a parallel port, game port or a universal serial bus (USB). A monitor 560 or other type of display device may also be connected to the system bus 501. The monitor 560 may also be integrated with a touch-screen panel or the like.

The computing device 500 may be implemented in a networked or cloud-computing environment using logical connections of a network interface 503 to one or more remote devices, such as a remote computer. The remote computer may be a personal computer, a server, a router, a network PC, a peer device or other common network node, and typically includes many or all of the elements described above relative to the computing device 500. The logical connection may include one or more local area networks (LAN) and one or more wide area networks (WAN), but may also include other networks. Such networking environments are commonplace in offices, enterprise-wide computer networks, intranets and the Internet.

When used in a networked or cloud-computing environment, the computing device 500 may be connected to a public and/or private network through the network interface 503. In such embodiments, a modem or other means for establishing communications over the network is connected to the system bus 501 via the network interface 503 or other appropriate mechanism. A wireless networking component including an interface and antenna may be coupled through a suitable device such as an access point or peer computer to a network. In a networked environment, program modules depicted relative to the computing device 500, or portions thereof, may be stored in the remote memory storage device.

Certain embodiments are described herein as including one or more modules. Such modules are hardware-implemented, and thus include at least one tangible unit capable of performing certain operations and may be configured or arranged in a certain manner. For example, a hardware-implemented module may comprise dedicated circuitry that is permanently configured (e.g., as a special-purpose processor, such as a field-programmable gate array (FPGA) or an application-specific integrated circuit (ASIC)) to perform certain operations. A hardware-implemented module may also comprise programmable circuitry (e.g., as encompassed within a general-purpose processor or other programmable processor) that is temporarily configured by software or firmware to perform certain operations. In some example embodiments, one or more computer systems (e.g., a standalone system, a client and/or server computer system, or a peer-to-peer computer system) or one or more processors may be configured by software (e.g., an application or application portion) as a hardware-implemented module that operates to perform certain operations as described herein.

Accordingly, the term “hardware-implemented module” encompasses a tangible entity, be that an entity that is physically constructed, permanently configured (e.g., hardwired), or temporarily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure the processor 502, for example, to constitute a particular hardware-implemented module at one instance of time and to constitute a different hardware-implemented module at a different instance of time.

Hardware-implemented modules may provide information to, and/or receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and may store the output of that operation in a memory device to which it is communicatively coupled. A further hardware-implemented module may then, at a later time, access the memory device to retrieve and process the stored output. Hardware-implemented modules may also initiate communications with input or output devices.

Computing systems or devices referenced herein, such as the computing devices 102 and 302 may include desktop computers, laptops, tablets, e-readers, personal digital assistants, smartphones, gaming devices, servers, and so on. The computing devices may access computer-readable media that include computer-readable storage media and data transmission media. In some embodiments, the computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on them or may be encoded with computer-executable instructions or logic that implements aspects of rule generation for cryptocurrency analysis set forth herein. The data transmission media may be used for transmitting data via transitory, propagating signals or carrier waves (e.g., electromagnetism) via a wired or wireless connection. The computing systems/devices may include a secure cryptoprocessor as part of a central processing unit for generating and securely storing keys and for encrypting and decrypting data using the keys.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method performed by a computing device for generating logic-based rules executable by the computing device for predicting cryptocurrency price reversals, comprising:
accessing a first dataset including textual information from the dark or deep web over a predetermined time period;
generating a plurality of tags from the textual information, each of the plurality of tags defining an entity identified from the textual information mapped to a time point from the predetermined time period associated with a mention of the entity;
defining a portion of the plurality of tags as spiking tags, each of the spiking tags defining by an entity mentioned over the predetermined time period in a frequency that satisfies a predefined threshold as determined by applying a statistical measurement that compares mentions of the entity on a given day with mentions to the entity over a predetermined number of days preceding the given day;
storing the spiking tags within a database as features along with historical cryptocurrency price movement data defining a list of dates and known cryptocurrency price reversals; and
applying annotated probabilistic temporal logic rule learning to learn temporal correlations between the features and the historical cryptocurrency price movement data and output a set of rules, each of the set of rules defining a probability of a cryptocurrency price reversal based on mentions of a given entity defined by the spiking tags.

2. The method of claim 1, further comprising assigning to each of the set of rules a significance value which corresponds to a measure of a percentage increase of the probability of each of the set of rules over a probability of a null rule having a same consequence.

3. The method of claim 2, wherein the significance value of each of the set of rules is high in value when the probability of each of the set of rules is greater than the probability of the null rule.

4. The method of claim 1, wherein the probability of a cryptocurrency price reversal is equal to a ratio of a number of mentions of the entity followed by known cryptocurrency price reversals within the predetermined number of days and a total number of times that the entity was mentioned.

5. The method of claim 4, wherein the given day is determined to be preceding the cryptocurrency price reversal when 1.5 times a sum of an average value for a predetermined number of days preceding the given day of a difference between a maximum and a minimum closing price for a predetermined number of proceeding days from the given day, and a standard deviation corresponding to the difference between the maximum and the minimum closing price for the predetermined number of proceeding days from the given day is less than or equal to the difference between the maximum and the minimum closing price for the predetermined number of proceeding days from the given day.

6. The method of claim 1, further comprising generating the plurality of tags using by implementing named entity recognition that classifies entities of the textual information into pre-defined categories.

7. The method of claim 1, wherein the database comprises a time series database optimized for time-stamped data or time series data and configured for computation by a processor of a percentile increase in references to particular keywords from the first dataset over a predetermined period of time.

8. The method of claim 1, wherein a cryptocurrency price reversal occurs if there is a fall in price of a predetermined percent after rising a predetermined number of days.

9. The method of claim 1, wherein a cryptocurrency price reversal is deemed to occur where a maximum difference in a set of closing prices over a predetermined number of days is greater than a threshold, and based on identification of multiple consecutive days of failing prices and of rising prices.

10. A system for generating rules executable by a computing device for predicting cryptocurrency price reversals, comprising:
a computing device, including:
a processor,
a database in operable communication with the processor, the database storing a first dataset defining textual information associated with cryptocurrency activities and a second dataset defining historical price reversals of cryptocurrency information, and
a memory storing a set of instructions executable by the processor, the set of instructions, when executed by the processor, operable to:
access the first dataset and the second dataset from the database,
identify a plurality of indicators of a cryptocurrency reversal from the first dataset, and
learn temporal correlations between the plurality of indicators of the first dataset and the historical price reversals of cryptocurrency information from the second dataset.

11. The system of claim 10, wherein the database comprises a time series database optimized for time-stamped data or time series data and configured for computation by the processor of a percentile increase in references to particular keywords from the first dataset over a predetermined period of time.

12. The system of claim 10, further comprising:
a remote computing device in operable communication with the computing device, the remote computing device configured for extracting the first dataset from the deep or dark web.

13. The system of claim 12, wherein the computing device accesses the first dataset from the remote computing device by way of an application programming interface provided by the remote computing device.

14. The system of claim 10, wherein the computing device is configured to execute a crawler to obtain the first dataset from the deep or dark web.

15. A tangible, non-transitory, computer-readable media having instructions encoded thereon, the instructions, when executed by a processor, are operable to:
access a first dataset associated with cryptocurrency activities;
map a set of predicates defined by the cryptocurrency activities from the first dataset to a plurality of time points;
access a second dataset including identifications of historical cryptocurrency price reversals; and
learn a set of rules based on temporal correlations between the set of predicates of the first dataset and information associated with the historical cryptocurrency price reversals from the second dataset.

16. The tangible, non-transitory, computer-readable media of claim 15, wherein the set of rules are learned based on the set of predicates that evaluate to a true value.

17. The tangible, non-transitory, computer-readable media of claim 15, wherein the instructions, when executed by the processor, are further operable to:
apply machine learning or knowledge representation and reasoning to the first dataset to derive the set of predicates from the cryptocurrency activities.

18. The tangible, non-transitory, computer-readable media of claim 15, wherein the set of predicates are based on activities, abnormalities, or a measured increase in references to predefined keywords within the first dataset.

19. The tangible, non-transitory, computer-readable media of claim 15, wherein the instructions, when executed by the processor, are further operable to:
determine a significance of a given one of the set of rules based on a percentage increase of a probability of the given one of the set of rules being found true over a probability of the given one of the set of rules being found null with a same consequence.

20. The tangible, non-transitory, computer-readable media of claim 15, wherein the set of rules define a logic program executable by the processor that predicts, for each rule, a trend reversal associated with cryptocurrency within t days following a spike in a predetermined activity with a probability p.
